(19) United States
(12) Patent Application Publication
(10) Pub. No.: US 2005/0042590 A1
(43) Pub. Date: Feb. 24, 2005

(54) Urethral sphincter simulator

(76) Inventors: Mark Howansky, Union City, NJ (US); Mosaddeq Hossain, Hillsborough, NJ (US); Stephen B. Wahlgren, Easton, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/645,914

(22) Filed: Aug. 21, 2003

(51) Int. Cl. G09B 23/28

(52) U.S. Cl. 434/262

(57) ABSTRACT

A device and method is provided for simulating a tubular body part having a mechanism for resisting fluid flow therethrough, such as the urethra. The device includes a housing having a having a first end, a second end, and a channel therethrough extending between an inlet at the first end of the housing and an outlet, and a plug member positioned within the channel and being sized and shaped to substantially occlude the channel at a predetermined location when a predetermined force is exerted on a first side thereof. The plug member is further movable within the channel so that, when a fluid force within the channel and exerted on a second opposite side of the plug member exceeds the predetermined force, the plug member no longer occludes the channel. The device further includes an adjustment member movably coupled to the housing and a compression member positioned within the channel in a compressed state so that a first end exerts pressure on the plug member and a second end exerts pressure on the adjustment member. The adjustment member is movable relative to the housing to thereby adjust the amount by which the compression member is compressed.

### FIELD OF THE INVENTION

This invention relates generally to devices that simulate structures in the human body, and more particularly to a device that effectively and reliably simulates the urethral sphincter

### BACKGROUND

Many millions of women worldwide suffer from some form of urinary incontinence. A majority of these women suffer from stress urinary incontinence (SUI), a condition in which involuntarily loss of urine occurs during normal daily activities and movements such as laughing, coughing, sneezing, and/or regular exercise. SUI may be caused by a functional defect of the tissue or ligaments connecting the vaginal wall with the pelvic muscles or bone. Common causes include repetitive straining of the pelvic muscles, childbirth, loss of pelvic muscle tone, and estrogen loss.

To address and treat incontinence it is important to diagnose what form of incontinence the patient has. Co-pending application publication no. 2003/0028074, which is incorporated herein by reference in its entirety, describes a new device and method for diagnosing SUI. As described therein, this new device and method measures the Urethral Resistance Pressure (URP), which is the pressure required to force open the urethral sphincter from the reverse direction. The obtained value provides an indicator as to whether the patient suffers from SUI. As further described in this application, the test involves inserting a meatus cone into the urethral meatus, infusing fluid through the meatus cone into the urethra until the pressure builds enough within the urethra to force it open. During fluid infusion pressure is simultaneously measured within the urethra (distal of the sphincter as well), with the corresponding pressure curve showing a stead rise initially, and then substantially leveling off once the sphincter opens, such as is seen in the graph of FIG. 8d of the publication.

One difficulty encountered in providing a device to test URP is finding a reliable and efficient way to test the device prior to patient use, or to demonstrate the functionality of the device other than on a human subject. The only known methods to do so involve animal studies or cadavers, where the device is tested/demonstrated on animal or human body parts. These test methods have obvious disadvantages as it is desirable to avoid animal studies and cadavers wherever possible. Further, such tests have proved insufficient and unreliable. To effectively test such a device one must be able to ensure that it will perform adequately under different human sphincter conditions ranging from healthy to unhealthy sphincters. Animal models do not adequately mimic the properties of human sphincters. Further, to assess the accuracy of the device, one must be able to test it against a known sphincter opening pressure, otherwise there is no way of knowing whether the URP readings shown by the device are accurate. This is obviously difficult, if not impossible, with animals or cadavers.

Accordingly, there is a need for a simulated artificial sphincter that is useful in conjunction with devices for testing URP or other incontinence or sphincter functionality tests.

### SUMMARY OF THE INVENTION

The present invention provides a device for simulating a tubular body part having a mechanism for resisting fluid flow therethrough. The device includes a housing having a having a first end, a second end, and a channel therethrough extending between an inlet at the first end of the housing and an outlet, and a plug member positioned within the channel and being sized and shaped to substantially occlude the channel at a predetermined location when a predetermined force is exerted on a first side thereof. The plug member is further movable within the channel so that, when a fluid force within the channel and exerted on a second opposite side of the plug member exceeds the predetermined force, the plug member no longer occludes the channel. The device further includes an adjustment member movably coupled to the housing and a compression member positioned within the channel in a compressed state so that a first end exerts force on the plug member and a second end exerts force on the adjustment member. The adjustment member is movable relative to the housing to thereby adjust the amount by which the compression member is compressed.

In one embodiment, the adjustment member is movable relative to the housing so that the predetermined force exerted by the compression member on the plug member can be selected to be any force in a physiological range substantially corresponding to the range of forces required to force open the urethral sphincter of a human patient. In yet another embodiment, the adjustment member is movable relative to the housing so that the predetermined force exerted by the compression member on the plug member can be selected to correspond to a pressure on the plug member within the range of approximately 20 to 180 mm Hg.

In an alternate embodiment, the channel includes a first channel portion extending inwardly from the housing inlet and a second channel portion in fluid communication with the first channel portion and with the housing outlet, and having a larger cross-section than the first channel portion. The outlet may further include at least one aperture extending from the second channel portion laterally portion.

According to one embodiment, the adjustment member is at least partially positioned within the opening at the distal end of the housing and is threadably engaged with the housing. The device may also further include a locking member for selectively fixedly securing the adjustment member through the housing, and also may further include an opening at the distal end of the housing and extending into the second channel in place relative to the housing.

In yet another embodiment, the device further includes a transition zone providing a transition from the first channel portion into the second channel portion, wherein a first end of the plug member and the transition zone have substantially complementary configurations.

In yet another embodiment, the device further includes an inflow port having a channel therethrough in fluid communication with the housing channel. The plug member may be comprised of a material selected from the following group: Teflon, polyethylene, polyurethane and silicone.

Also provided is a human urethral sphincter simulator device including a housing having a channel therethrough extending between an inlet and an outlet, and an obstruction member positioned within the housing and relative to the channel so as to obstruct the channel and substantially block fluid flow therethrough when a predetermined force is exerted thereon. The obstruction member is further movable within the channel so that, when a fluid force within the first channel portion exceeds the predetermined force, the obstruction member moves so that it no longer prevents fluid flow through the channel. The simulator further includes a means for exerting the predetermined force on the obstruction member. The means for exerting the predetermined force is adjustable so that the predetermined force can be selected to be a force that substantially corresponds to that which would open a human urethral sphincter.

A method is also provided for simulating a human sphincter, including the steps of providing a device including housing having a having a channel therethrough extending between an inlet at the first end of the housing and an outlet, and a plug member positioned within the channel and sized and shaped to substantially block fluid flow therethrough when a predetermined force is exerted on a first side of the plug member. The plug member is further movable within the channel so that, when a fluid force within the channel and exerted on a second opposite side of the plug member exceeds the predetermined force, the plug member no longer prevents fluid flow through the channel. The device also includes an adjustment member movably coupled to the housing, and a compression member positioned within the channel in a compressed state so that a first end exerts pressure on the plug member and a second end exerts pressure on the adjustment member. The method further includes the steps of moving the adjustment member relative to the housing until the compression member exerts the predetermined force on the plug member, and infusing fluid into the channel so as to exert pressure on the second side of the plug member using an infusion device until the force of the infused fluid against the plug member exceeds the predetermined force.

These and other features and advantages of the present invention will become apparent from the following more detailed description, when taken in conjunction with the accompanying drawings which illustrate, by way of example, the principles of the invention.

### BRIEF DESCRIPTION OF THE DRAWINGS

FIG. 1 is a front view of a urethral sphincter simulator according to the present invention coupled to a device for measuring URP;

FIG. 2 is a partial cut-away view of the urethral sphincter simulator of FIG. 1;

FIG. 3 is an exploded view of the urethral sphincter simulator of FIG. 1;

FIG. 4 is a perspective view of an adjustment member for use with the urethral sphincter simulator of FIG. 1; and

FIG. 5 is a perspective view of a valve plug for use with the urethral sphincter simulator of FIG. 1.

### DETAILED DESCRIPTION

Before explaining the present invention in detail, it should be noted that the invention is not limited in its application or use to the details of construction and arrangement of parts illustrated in the accompanying drawings and description, because the illustrative embodiments of the invention may be implemented or incorporated in other embodiments, variations and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

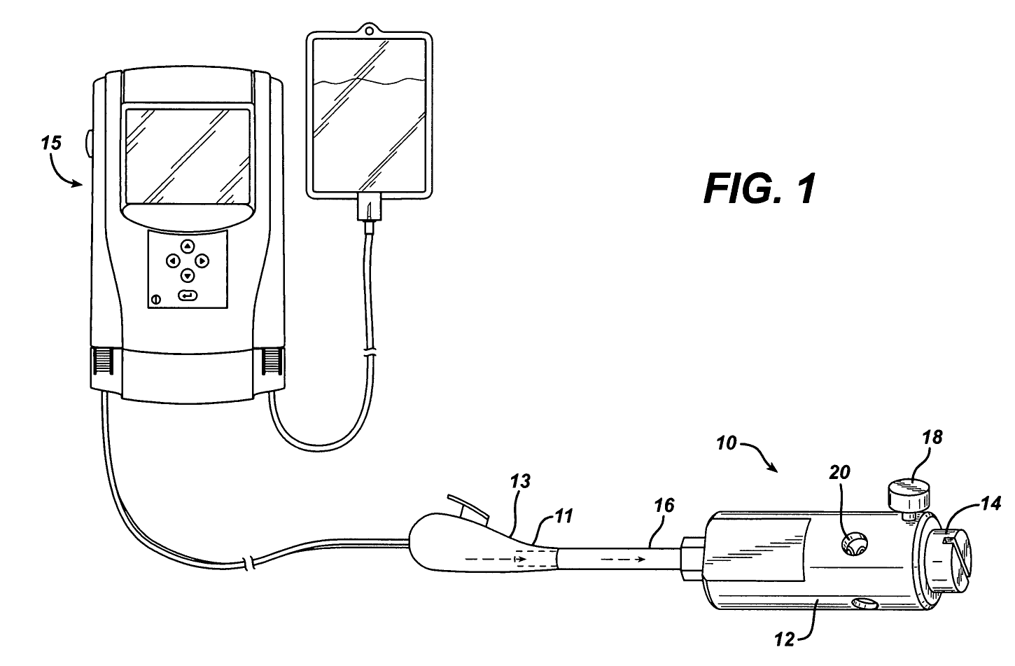

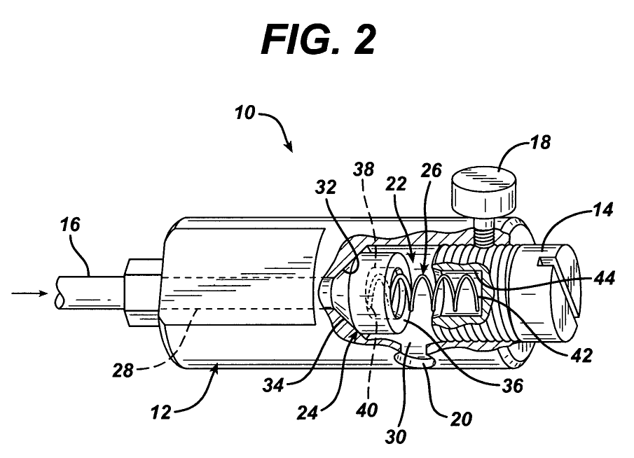

Referring now to FIG. 1, one embodiment of a urethral sphincter simulator 10 according to the present invention is shown including a housing 12, an adjustment member 14, a fluid inflow port 16, a locking device 18, and one or more apertures 20 extending into a channel 22 (shown in FIG. 2) that extends through the housing 12. Positioned within the channel 22 are plug or obstruction member 24 and compression member 26 as shown in FIG. 2.

Inflow port 16 of the urethral sphincter simulator 10 is designed to be coupled with a device 15 for infusing fluid into the simulator in the direction indicated by the arrow in FIG. 1. Accordingly to a preferred embodiment, inflow device 15 is a device for assessing urinary incontinence, and in particular a device for assessing URP such as that shown in patent publication number 2003/0028074, which is incorporated herein by reference in its entirety. This device 15 includes a meatus plug 11 (as also shown and described in publication number 2003/0028074) the end of which is received within inflow port 16 and through which the fluid is infused.

As shown in detail in a preferred embodiment of FIG. 2, channel 22 includes a first channel portion 28 that extends into the urethral sphincter simulator from the inflow port 16, and which opens up into a second channel portion 30 of larger diameter than the first channel portion. A plug member 24 is positioned so as to rest in the transition zone 32 from the first to the second channel portion. The plug is further dimensioned so that at least a portion of its distal end 34 is substantially complementary to the transition zone so that when positioned within the transition zone, the plug will block the flow of infused fluid from the first channel portion into the second channel portion. Other configurations, however, are also possible so long as the plug is sized and shaped to substantially block fluid flow into the second channel portion if enough pressure is exerted on it. In addition, although the illustrated embodiment shows the obstruction member positioned within the channel 22, it may also simply be positioned relative to the channel so that it obstructs the channel when a predetermined force is exerted thereon. For example, an obstruction member could be positioned outside of a flexible tubing forming the channel, and be designed to pinch off the channel when under a predetermined amount of force.

At the proximal end 36 of the plug member is a recess 38 sized and shaped to receive therein the distal end 40 of a compression member 26 such as the illustrated spring. The proximal end 42 of the compression member 26 is similarly received within a recess 44 in adjustment member 14.

During operation of the urethral sphincter simulator, fluid is infused into the inflow port 16 as described above. Compression member 26 is sufficiently compressed between the adjustment member and the plug member so as to initially exert enough force on the plug member to force it to be seated within the transition zone and thereby prevent fluid from flowing into the second channel portion. As fluid continues to be infused into first channel portion pressure continues to build therein, until the pressure is sufficient to overcome the force of the compression member and unseat the plug member, causing fluid to flow into the second channel and out through apertures 20. Thus, the pressure within the fluid inflow tube and/or first channel portion will rise steadily as fluid is infused therein, and then substantially level off rapidly once the plug member unseats and fluid is permitted to freely flow through and out of the simulator. This is analogous to that which should occur with a human sphincter.

The device of the present invention is further optimized to simulate the urethral sphincter in a number of ways. First, the compression member is designed to mimic physiologically properties of the sphincter. By this it is meant that the spring force selected is designed to mimic and work under the full range of pressures that would be required to force open the human sphincter, for both healthy and unhealthy sphincters. In this manner the urethral sphincter simulator can be used to ensure that a test device is working appropriately throughout the full range of pressures that might be encountered. In one embodiment, the compression member is a spring. Other suitable types of compression members could include compressible rubber or other elastic material, or a compressible piston or the like.

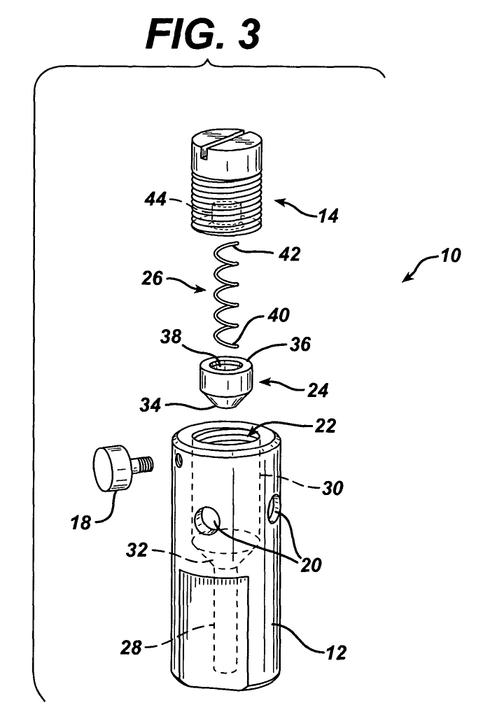

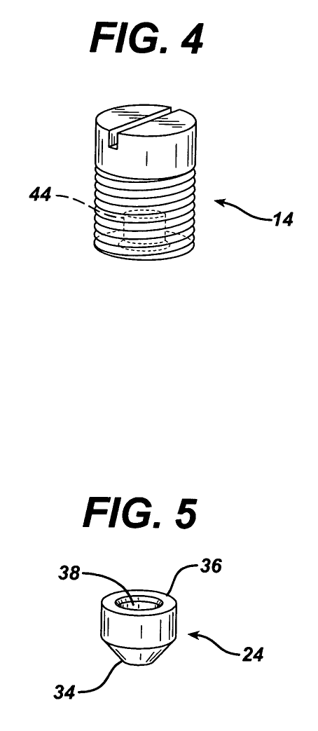

Second, the adjustment member 14 enables fine tuning of the simulator so that the test device can be tested or demonstrated at any given sphincter opening pressure within the physiological range described above. As is best seen in FIGS. 2 and 3, the adjustment member 14 is externally threaded with a thread size designed to mate with internal threads that exist on at least a portion of the inner surface of the second channel within the housing. Thus, as the adjustment member continues to be screwed into the housing, the compression member 26 becomes increasingly compressed and exerts an increasing amount of force on both the adjustment member and the plug member. This, in turn, will require a greater amount of pressure within the first channel portion to unseat the plug member. In the described embodiment using a spring of the type specified above and a sphincter simulator device having dimensions set forth in the figures, one full rotation of the adjustment member translates into approximately and additional 20mm Hg of pressure required to unseat the plug member. When the adjustment member is positioned as desired, a locking member such as set screw 18 can be used to prevent additional unwanted rotation of the adjustment member.

The housing, adjusting screw and locking screw of the urethral sphincter simulator may be comprised of any suitable material, such as stainless steel. The plug member should be comprised of a material that is sufficiently durable, will form a sufficient seal when seated, and will freely move under the influence of the fluid and compression member (minimal friction between the plug member and the housing). One suitable material is Teflon.

Although the present invention has been described in detail with reference to simulating a urethral sphincter, those skilled in the art will recognize that the inventive simulator device can readily be used to simulate other body sphincters, valves or other parts that resist fluid flow until overcome by a given pressure. It will be apparent from the foregoing that various modifications can be made without departing from the spirit and scope of the invention. Accordingly, it is not intended that the invention be limited, except by the appended claims.

1. A device for simulating a tubular body part having a mechanism for resisting fluid flow therethrough, comprising:
a housing having a having a first end, a second end, and a channel therethrough extending between an inlet at the first end of the housing and an outlet;
a plug member positioned within the channel and being sized and shaped to substantially occlude the channel at a predetermined location when a predetermined force is exerted on a first side thereof, the plug member further being movable within the channel so that, when a fluid force within the channel and exerted on a second opposite side of the plug member exceeds the predetermined force, the plug member no longer occludes the channel;
an adjustment member movably coupled to the housing; and
a compression member positioned within the channel in a compressed state so that a first end exerts force on the plug member and a second end exerts force on the adjustment member,
wherein the adjustment member is movable relative to the housing to thereby adjust the amount by which the compression member is compressed.

2. The device according to claim 1, wherein the adjustment member is movable relative to the housing so that the predetermined force exerted by the compression member on the plug member can be selected to be any force in a physiological range substantially corresponding to the range of forces required to force open the urethral sphincter of a human patient.

3. The device according to claim 1, wherein the adjustment member is movable relative to the housing so that the predetermined force exerted by the compression member on the plug member can be selected to correspond to any pressure on the plug member within the range of approximately 20 to 180 mm Hg.

4. The device according to claim 1, wherein the channel includes a first channel portion extending inwardly from the housing inlet and a second channel portion in fluid communication with the first channel portion and with the housing outlet, and having a larger cross-section than the first channel portion.

5. The device according to claim 4, wherein the outlet further comprises at least one aperture extending from the second channel portion laterally through the housing.

6. The device according to claim 5, further comprising an opening at the distal end of the housing and extending into the second channel portion.

7. The device according to claim 6, wherein the adjustment member is at least partially positioned within the opening at the distal end of the housing and is threadably engaged with the housing.

8. The device according to claim 7, further comprising a locking member for selectively fixedly securing the adjustment member in place relative to the housing.

9. The device according to claim 4, further comprising a transition zone providing a transition from the first channel portion into the second channel portion, wherein a first end of the plug member and the transition zone have substantially complementary configurations.

10. The device according to claim 1, further comprising an inflow port having a channel therethrough in fluid communication with the housing channel.

11. The device according to claim 1, wherein the plug member is comprised of a material selected from the group consisting of Teflon, polyethylene, polyurethane and silicone.

12. A human urethral sphincter simulator device, comprising:
a housing having a channel therethrough extending between an inlet and an outlet;
an obstruction member positioned within the housing and relative to the channel so as to substantially block fluid flow therethrough when a predetermined force is exerted thereon, the obstruction member further being movable within the channel so that, when a fluid force within the first channel portion exceeds the predetermined force, the obstruction member moves so that it no longer prevents fluid flow through the channel;
means for exerting the predetermined force on the obstruction member;
wherein the means for exerting the predetermined force is adjustable so that the predetermined force can be selected to be a force that substantially corresponds to that which would open a human urethral sphincter.

13. The device according to claim 12, wherein the predetermined force can be selected to correspond to any pressure on the plug member within the range of approximately 20 to 180 mm Hg.

14. The device according to claim 12, wherein the means for exerting force further comprises a compression member and an adjustment member, wherein the compression member has a first end exerting a force on the obstruction member and a second end exerting a force on adjustment member, and wherein the adjustment member is movable relative to the housing to compress the compression member more or less.

15. The device according to claim 14, wherein the adjustment member is threadably engaged with the housing, and the predetermined force is selected by threadably moving the adjustment member.

16. A method for simulating a human sphincter, comprising:
providing a device including housing having a having a channel therethrough extending between an inlet at the first end of the housing and an outlet, a plug member positioned within the channel and sized and shaped to substantially block fluid flow therethrough when a predetermined force is exerted on a first side of the plug member, the plug member further being movable within the channel so that, when a fluid force within the channel and exerted on a second opposite side of the plug member exceeds the predetermined force, the plug member no longer prevents fluid flow through the channel, an adjustment member movably coupled to the housing, and a compression member positioned within the channel in a compressed state so that a first end exerts pressure on the plug member and a second end exerts pressure on the adjustment member,
moving the adjustment member relative to the housing until the compression member exerts the predetermined force on the plug member;
infusing fluid into the channel so as to exert pressure on the second side of the plug member using an infusion device until the force of the infused fluid against the plug member exceeds the predetermined force.
